(19) United States
(12) Patent Application Publication
(10) Pub. No.: US 2025/0384253 A1
(43) Pub. Date: Dec. 18, 2025

(54) PRIVACY-PRESERVING MULTI-PARTY JOINT MODEL PREDICTION METHODS, SYSTEMS, AND APPARATUSES

(71) Applicant: Alipay (Hangzhou) Information Technology Co., Ltd., Hangzhou (CN)

(72) Inventors: Anda CHENG, Hangzhou (CN); Yinggui WANG, Hangzhou (CN); Lei WANG, Hangzhou (CN)

(21) Appl. No.: 19/237,100

(22) Filed: Jun. 13, 2025

(30) Foreign Application Priority Data
Jun. 14, 2024 (CN) 202410773446.1

(51) Int. Cl. G06N 3/048

(52) U.S. Cl. CPC G06N 3/048

(57) ABSTRACT

Embodiments of this specification provide privacy-preserving multi-party joint model prediction methods, systems, and apparatuses. A computing device converts all nonlinear activation functions in a service prediction model into corresponding linear activation functions, where any nonlinear activation function is converted into linear functions of several segments, any linear function is obtained by performing Taylor expansion on the nonlinear activation function at a Taylor expansion point in a corresponding segment, and in the segment, a difference between the linear function and the nonlinear activation function is less than a preset threshold. Then, a first participant and a second participant perform data exchange based on secure multi-party computation according to a logical operation indicated by the linear activation function included in the service prediction model, to jointly perform a prediction process of the service prediction model, where the secure multi-party computation is more applicable to calculation of the linear activation function.

### TECHNICAL FIELD

One or more embodiments of this specification relate to the field of computer technologies, and in particular, to privacy-preserving multi-party joint model prediction methods, systems, and apparatuses.

### BACKGROUND

Data needed for machine learning usually relates to a plurality of platforms and a plurality of fields. For example, in a machine learning-based merchant classification and analysis scenario, an electronic payment platform has transaction data of a merchant, an electronic commerce platform stores sales data of the merchant, and a bank organization has debit and credit data of the merchant. To improve a service, the plurality of parties often jointly train or use a service prediction model while ensuring privacy and security of service data.

Secure multi-party computation (MPC) is a new secure computation mode, and can implement secure computation and data sharing between a plurality of parties without disclosing private data. To resolve a privacy protection problem in a model prediction scenario, a plurality of participants can perform, through MPC computation, common data calculation and interaction on functions included in the service prediction model, to ensure that personal data of the plurality of participants is not disclosed. However, application of the MPC in multi-party joint data processing is still subject to various limitations.

Therefore, it is expected that there can be an improved solution that can improve efficiency and accuracy of jointly performing model prediction processing by a plurality of parties while protecting private data of the plurality of parties.

### SUMMARY

One or more embodiments of this specification describe privacy-preserving multi-party joint model prediction methods, systems, and apparatuses. Specific technical solutions are as follows:

According to a first aspect, one or more embodiments provide a privacy-preserving multi-party joint model prediction method, where the method includes:
converting, by a computing device, all nonlinear activation functions in a service prediction model into corresponding linear activation functions, where a linear activation function converted from any nonlinear activation function includes linear functions of several segments, the linear function is obtained by performing Taylor expansion on the nonlinear activation function at a Taylor expansion point in a corresponding segment, and in the segment, a difference between the linear function and the nonlinear activation function is less than a preset threshold; and
performing, by a first participant and a second participant, data exchange based on secure multi-party computation according to a logical operation indicated by the linear activation function included in the service prediction model, to jointly perform a prediction process of the service prediction model, where the secure multi-party computation is used to perform data processing based on the linear activation function.

In an implementation, the step of converting all nonlinear activation functions in a service prediction model into corresponding linear activation functions includes:
for any nonlinear activation function, alternately searching for endpoints and Taylor expansion points of several segments, so that a difference between a linear function in any segment and the nonlinear activation function is less than the preset threshold; and
determining the linear activation function of the nonlinear activation function based on the obtained several segments and corresponding linear functions.

In an implementation, the step of alternately searching for endpoints and Taylor expansion points of several segments includes:

Initially, using a preset point as a Taylor expansion point.

In an implementation, the step of alternately searching for endpoints and Taylor expansion points of several segments includes:
in a preset interval, alternately searching for the endpoints and the Taylor expansion points of the several segments, where in another interval different from the preset interval, the nonlinear activation function approximates a fixed value.

The step of determining the linear activation function of the nonlinear activation function includes:
determining the obtained several segments and the corresponding linear functions, and the another interval and the corresponding fixed value as the linear activation function of the nonlinear activation functions.

In an implementation, the step of alternately searching for endpoints and Taylor expansion points of several segments includes:
when a Taylor expansion point is known, searching for an endpoint of a segment in which the Taylor expansion point is located, so that a difference between the first linear function and the nonlinear activation function is less than the preset threshold in a data interval between the Taylor expansion point and the endpoint, where the first linear function is obtained by performing Taylor expansion on the nonlinear activation function at the Taylor expansion point; and
when an endpoint of a segment is known, searching for a Taylor expansion point in the segment, so that a difference between a second linear function and the nonlinear activation function is less than the preset threshold in a data interval between the endpoint and the Taylor expansion point, where the second linear function is obtained by performing Taylor expansion on the nonlinear activation function at the Taylor expansion point.

In an implementation, the step of searching for an endpoint of a segment in which the Taylor expansion point is located includes:
successively determining values of the endpoint by using the Taylor expansion point as a start value point;
calculating function values of the first linear function and the nonlinear activation function at each value point; and
when a difference between the two function values is not less than the preset threshold, determining a previous value point of the value point as a value of the endpoint.

In an implementation, the step of searching for a Taylor expansion point in the segment includes:
successively determining values of the Taylor expansion point by using the endpoint as a start value point;
calculating corresponding function values respectively of the second linear function and the nonlinear activation function at the endpoint; and
when a difference between the two function values is not less than the preset threshold, determining a previous value of the Taylor expansion point as a value of the Taylor expansion point in the segment.

In an implementation, the linear function takes a preset quantity of terms in a corresponding Taylor series.

According to a second aspect, one or more embodiments provide a privacy-preserving multi-party joint model prediction method performed by a first participant, where the method includes:
determining all linear activation functions in a service prediction model, where all the nonlinear activation functions in the service prediction model are converted into corresponding linear activation functions, a linear activation function converted from any nonlinear activation function includes linear functions of several segments, the linear function is obtained by performing Taylor expansion on the nonlinear activation function at a Taylor expansion point in a corresponding segment, and in the segment, a difference between the linear function and the nonlinear activation function is less than a preset threshold; and
performing data exchange with a second participant based on secure multi-party computation according to a logical operation indicated by the linear activation function, to jointly perform a prediction process of the service prediction model, where the secure multi-party computation is used to perform data processing based on the linear activation function.

According to a third aspect, one or more embodiments provide a privacy-preserving multi-party joint model prediction system, where the system includes:
a computing device, configured to convert all nonlinear activation functions in a service prediction model into corresponding linear activation functions, where a linear activation function converted from any nonlinear activation function includes linear functions of several segments, the linear function is obtained by performing Taylor expansion on the nonlinear activation function at a Taylor expansion point in a corresponding segment, and in the segment, a difference between the linear function and the nonlinear activation function is less than a preset threshold; and
a first participant and a second participant, configured to perform data exchange based on secure multi-party computation according to a logical operation indicated by the linear activation function included in the service prediction model, to jointly perform a prediction process of the service prediction model, where the secure multi-party computation is used to perform data processing based on the linear activation function.

According to a fourth aspect, one or more embodiments provide a privacy-preserving multi-party joint model prediction apparatus deployed in a first participant, where the apparatus includes:
a function determining module, configured to determine all linear activation functions in a service prediction model, where all the nonlinear activation functions in the service prediction model are converted into corresponding linear activation functions, a linear activation function converted from any nonlinear activation function includes linear functions of several segments, the linear function is obtained by performing Taylor expansion on the nonlinear activation function at a Taylor expansion point in a corresponding segment, and in the segment, a difference between the linear function and the nonlinear activation function is less than a preset threshold; and
a joint calculation module, configured to perform data exchange with a second participant based on secure multi-party computation according to a logical operation indicated by the linear activation function, to jointly perform a prediction process of the service prediction model, where the secure multi-party computation is used to perform data processing based on the linear activation function.

According to a fifth aspect, one or more embodiments provide a computer-readable storage medium. The computer-readable storage medium stores a computer program. When the computer program is executed in a computer, the computer is enabled to perform the method in any implementation of the first aspect and the second aspect.

According to a sixth aspect, one or more embodiments provide a computing device, including a memory and a processor. The memory stores executable code. When the processor executes the executable code, the method in any implementation of the first aspect and the second aspect is implemented.

In the methods and the apparatuses provided in the embodiments of this specification, the computing device can convert all the nonlinear activation functions in the service prediction model into the linear activation functions. This conversion can satisfy a requirement of secure multi-party computation, so that a plurality of participants perform data exchange according to the logical operation indicated by the linear activation function, to jointly perform model prediction. Multi-party joint model prediction is implemented without using a more complex algorithm. In addition, because a difference between the converted linear activation function and the nonlinear activation function is less than the preset threshold, secure multi-party computation performed in the manner in the embodiments of this specification can improve efficiency and accuracy of multi-party joint model prediction while protecting private data.

### BRIEF DESCRIPTION OF DRAWINGS

To describe the technical solutions of the embodiments of this specification more clearly, the following briefly describes the accompanying drawings required for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram illustrating an implementation scenario, according to one or more embodiments of in this specification;

FIG. 2 is a schematic flowchart illustrating a privacy-preserving multi-party joint model prediction method, according to one or more embodiments;

FIG. 3 is a schematic diagram illustrating converting a nonlinear activation function into a segmented linear activation function, according to one or more embodiments;

FIG. 4 is another schematic flowchart illustrating a privacy-preserving multi-party joint model prediction method, according to one or more embodiments;

FIG. 5 is a schematic block diagram illustrating a privacy-preserving multi-party joint model prediction system, according to one or more embodiments; and

FIG. 6 is a schematic block diagram illustrating a privacy-preserving multi-party joint model prediction apparatus, according to one or more embodiments.

### DESCRIPTION OF EMBODIMENTS

The following describes the solutions provided in this specification with reference to the accompanying drawings.

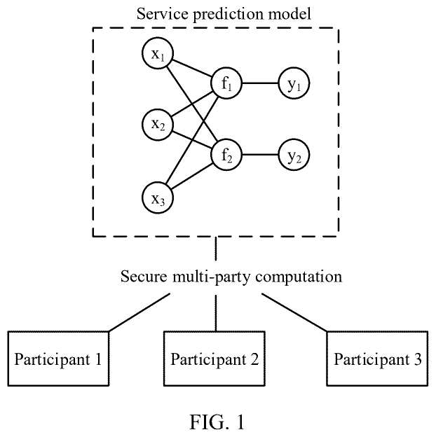

FIG. 1 is a schematic diagram illustrating an implementation scenario, according to one or more embodiments of this specification. Participants 1, 2, and 3 perform joint model processing based on a service prediction model through secure multi-party computation. FIG. 1 is merely an example. A quantity of participants can be two or three or more.

There can be a plurality of specific application scenarios between the service prediction model and a plurality of participants. In an application scenario, one of the plurality of participants is a model owner (referred to as a model party), and another party is a data owner (referred to as a data party). Generally, the model party can be one party, and the data party can be one or more parties. The data party has personal data, and the model party has the service prediction model. The data party can use the service prediction model owned by the model party to perform prediction. In different application scenarios, the plurality of participants have their own personal data, and each a part of calculation layer in the service prediction model, that is, have a model parameter at the part of calculation layer, and parts of calculation layer of the plurality of participants jointly form the complete service prediction model. The plurality of participants jointly train the service prediction model by using the personal data owned by the participants. The model parameter and/or the private data that are owned by each party include/includes personal data that cannot be sent to the outside in plaintext. In the scenario of multi-party joint model training, the private data should not be disclosed as much as possible.

Corresponding to the above-mentioned application scenario, in a training process, the plurality of participants can jointly train the service prediction model through secure multi-party computation. After training of the service prediction model is completed, the plurality of participants can jointly perform service prediction by using the service prediction model through secure multi-party computation.

The service prediction model is used to perform service prediction on input service data. The service prediction includes performing user risk classification on input user information, performing transaction risk classification on an input transaction, performing pushability scoring on input user information and product information, and so on. The service prediction model can be implemented by a network model such as a convolutional neural network or a cyclic neural network. The service prediction model can alternatively be a language model, such as a large language model. In a reasoning scenario, the large language model can be used to perform secure reasoning on text data input by a user. After the MPC technology is used, in a reasoning process, model parameters of the large language model and user query content (that is, the text data input by the user) are all cryptographic, thereby avoiding disclosure of query content.

Various activation functions are usually used in the service prediction model. The calculation layer of the service prediction model can include several activation functions.

The activation function aims to help a network model learn a complex mode in data. An activation function at a node defines an output of the node under a given input or an input set. For example, in FIG. 1, an input of an activation function f₁ is x₁, x₂, and x₃, and an output is y₁; and an input of an activation function f₂ is x₁, x₂, and x₃, and an output is y₂. The activation function is a data equation that determines an output of the network model. The activation function includes a linear activation function and a nonlinear activation function. Introducing the nonlinear activation function into the network model can improve a learning capability and a representation capability of the network model, thereby better fitting a target function. The nonlinear activation function includes, for example, a Sigmoid function, a Softmax function, and a Tanh function, and the linear activation function includes, for example, a ReLU function. When an activation function can be represented by using only an addition operation and/or a multiplication operation, where the addition includes subtraction, the function can be referred to as a linear activation function. For example, common linear functions, quadratic functions, cubic functions, etc. are all linear activation functions. When an activation function cannot be represented by using only an addition operation and/or a multiplication operation, the activation function is a nonlinear activation function. For example, an independent variable x of the nonlinear activation function is on a denominator or on an exponent, and such functions are all nonlinear activation functions.

Secure multi-party computation (MPC) is an existing data privacy protection technology for participation by a plurality of parties. A specific implementation of the MPC includes technologies such as homomorphic encryption, a garbled circuit, oblivious transfer, and secret sharing. The MPC usually can perform data calculation based on addition and multiplication, that is, can perform data calculation or processing based on a linear activation function.

The following specifically describes, by using an example, a process in which a plurality of participants perform data exchange based on secure multi-party computation according to a logical operation indicated by a linear activation function. The process includes a combination of the secure multi-party computation and the linear activation function, and also includes a data exchange process between the plurality of participants. In an application scenario including a model party and a data party, a linear activation function f(X)=W*X is used as an example to describe an interaction process between a plurality of parties. W is a model parameter matrix and belongs to the model party; and X is a service data matrix and belongs to the data party. Both W and X include private data that cannot be sent to the outside in plaintext.

A secret sharing technology is used as an example of the secure multi-party computation. Joint data processing performed between a plurality of participants includes an offline phase and an online phase.

Step 1: In the offline phase, the model party and the data party separately obtain offline factors (U₁, V₁, G₁) and (U₂, V₂, G₂), where the matrices U₁ and U₂ herein have a same dimension as W, the matrices V₁ and V₂ have a same dimension as X, and (U₁+U₂)*(V₁+V₂) (G₁+G₂) is satisfied. This is the offline phase.

Step 2: The model party randomly generates a matrix W₁, obtains a fragment W₂=W−W₁, and sends W₂ to the data party. In addition, the data party also randomly generates a matrix X₂, obtains a fragment X₁=X−X₂, and sends X₁ to the model party. In this way, the model party and the data party respectively have W₁ and X₁ and W₂ and X₂.

Step 3: Calculate D and E in a finite field. The model party performs calculation based on the following formulas: D₁=W₁−U₁, and E₁=X₁−V₁. The data party performs calculation based on the following formulas: D₂=X₂−U₂, and E₂=X₂−V₂. Both parties exchange D₁ and E₁ and D₂ and E₂.

Step 4: The model party obtains a fragment Z₁ by calculating the following formula:

$$\begin{matrix}D = {D}_{1} + {D}_{2} , E = {E}_{1} + {E}_{2} \\ {Z}_{1} = {G}_{1} + E \cdot {U}_{1} + D \cdot {V}_{1} + D \cdot E\end{matrix}$$

The data party obtains a fragment Z₂ by calculating the following formula:

$$\begin{matrix}D = {D}_{1} + {D}_{2} , E = {E}_{1} + {E}_{2} \\ {Z}_{2} = {G}_{2} + E \cdot {U}_{2} + D \cdot {V}_{2}\end{matrix}$$

It can be verified that Z₁+Z₂−W·X.

Therefore, the two participants respectively obtain the matrix multiplication fragments Z₁ and Z₂ without exposing the original matrices W and X. The above-mentioned steps 2, 3, and 4 are all in the online phase. Joint data processing shown in the above-mentioned online phase is merely an example, and does not constitute a limitation on this specification. In actual application, a joint data processing process in the online phase can further be in more other manners.

An offline factor can be a group of random arrays including a plurality of random numbers. The offline factors (U₁, V₁, G₁) and (U₂, V₂, G₂) each form a random array. In the online phase, random numbers is combined with service data or model parameters to obtain a hidden matrix of the service data or the model parameters. Based on the hidden matrix, the participants can perform joint data processing. In each time of joint data processing, random arrays should be different to ensure data privacy.

In the above-mentioned manner, the model party and the data party perform data exchange based on secure multi-party computation according to the logical operation W*X indicated by the linear activation function, to implement joint data processing. When the service prediction model includes several linear activation functions, interaction can be performed based on the above-mentioned description in a data processing sequence in the service prediction model, thereby implementing secure multi-party joint model prediction. For example, if an output of the activation function f₁ is an input of an activation function f₃, logical operations of f₁ and f₃ can be sequentially performed based on the above-mentioned description. “Several” includes one or more.

With continuous improvement of a technology, a structure in the service prediction model is increasingly complex, there are increasingly more parameters, and a quantity of nonlinear activation functions is also very large. In a multi-party joint model prediction scenario, because the service prediction model includes many nonlinear activation functions, it is difficult to combine the model with secure multi-party computation, or secure multi-party computation is implemented in a more complex manner.

To improve efficiency and accuracy of multi-party joint model prediction while protecting data privacy, one or more embodiments of this specification provide a multi-party joint model prediction method. In the method, all nonlinear activation functions in a service prediction model are converted into corresponding linear activation functions, where a linear activation function converted from any nonlinear activation function includes linear functions of several segments, a linear function is obtained by performing Taylor expansion on the nonlinear activation function at a Taylor expansion point in a corresponding segment, and in the segment, a difference between the linear function and the nonlinear activation function is less than a preset threshold. In this way, a plurality of participants can perform data exchange based on secure multi-party computation according to a logical operation indicated by the linear activation function included in the service prediction model, to jointly perform a prediction process of the service prediction model.

In the one or more embodiments, linear functions of several segments are used to implement high-precision replacement of the nonlinear activation function, and a linear requirement of secure multi-party computation can be supported, thereby ensuring security of private data and improving efficiency and accuracy of multi-party joint model prediction.

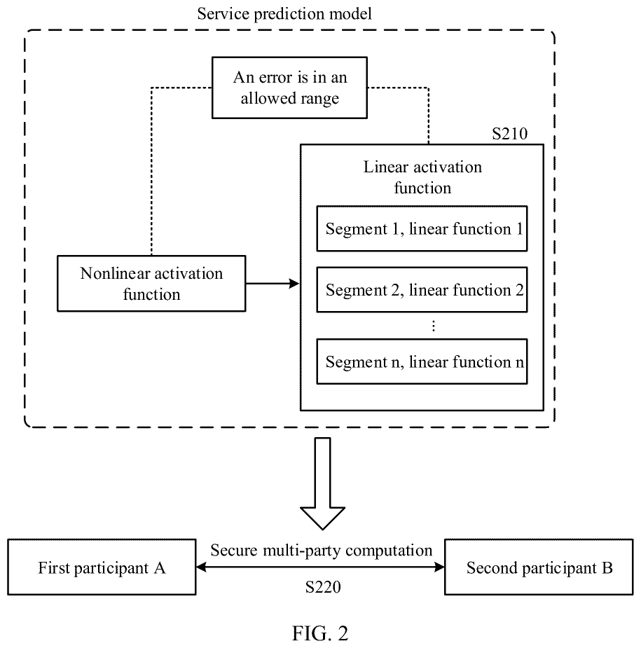

The following describes the one or more embodiments in detail with reference to FIG. 2.

FIG. 2 is a schematic flowchart of a privacy-preserving multi-party joint model prediction method, according to one or more embodiments. For ease of description, two participants are used as an example for description in most of the following examples. For example, the two participants are respectively a first participant A and a second participant B. A computing device can be the first participant A or the second participant B.

In an implementation, the first participant A can be a model owner, and the second participant B can be a data owner and has personal data. In different implementations, both the first participant A and the second participant B can have personal data, and jointly own a service prediction model.

In step S210, a computing device converts all nonlinear activation functions in a service prediction model into corresponding linear activation functions.

A linear activation function f1′ converted from any nonlinear activation function f₁ includes a linear function 1 of a segment 1, a linear function 2 of a segment 2, . . . , and a linear function n of a segment n, where n is a integer greater than 1. Segmentation refers to interval division performed on a value range of an input data x of the nonlinear activation function f₁. A plurality of segments are usually connected to each other, and endpoints of adjacent segments overlap.

Herein, all the n linear functions or some linear functions are obtained by performing Taylor expansion on the nonlinear activation function f₁ at a Taylor expansion point in a corresponding segment. In other words, all the linear functions can be obtained through Taylor expansion, or only some linear functions are obtained through Taylor expansion. A linear function obtained through Taylor expansion is actually a polynomial function, and a converted linear activation function is actually a segmented polynomial function.

A Taylor series is a formula that describes a value near a point by using information of a function at the point. The linear function obtained through Taylor expansion is obtained by taking a preset quantity of terms in a corresponding Taylor series. In other words, this linear function is a polynomial that includes a preset quantity of items, and is obtained by successively taking the preset quantity of items from a 0 power term of an independent variable x in the Taylor series, that is, taking the preset quantity of first items in the Taylor series. This linear function includes a low-power term of the independent variable x. When operation logic of the converted linear activation function is executed through secure multi-party computation, a relatively high power included in the function does not cause a relatively high calculation amount. Therefore, the low power term of the independent variable x in the linear function helps reduce the calculation amount.

A Taylor series of a function f(x) at x=a is in the following form:

$$\begin{matrix}\begin{matrix}\begin{matrix}f ( x ) = f ( a ) + {f}^{′} ( a ) ( x - a ) + ( 1 / 2 ! )\end{matrix} \\ {f}^{″} ( a ) {( x - a )}^{2} + ... + ( 1 / n ! )\end{matrix} \\ {f}^{n} ( a ) {( x - a )}^{n} +\end{matrix} \qquad ( 1 )$$

where f(a) represents a function value of the function f(x) at an expansion point a, f(a) represents a first-order derivative value of f(x) at the expansion point a, and fⁿ (a) represents an n^{th}-order derivative value of f(x) at the expansion point a. The preset quantity of first items refers to a preset quantity of items that start from a right side of an equal sign of the equation (1). The preset quantity can be preset, for example, can be set to values such as 3, 4, and 5.

In any segment, a difference between the linear function and the nonlinear activation function f₁ is less than a preset threshold. The preset threshold can be set to a relatively small value based on experience, so that an error between the converted linear activation function f1′ and the nonlinear activation function f₁ is in an allowed range.

Independent variable x of the function is input data of the function. A value of x can be input data of a model, or can be intermediate data in the model. The model refers to the service prediction model. The nonlinear activation function f₁ can include a model parameter, or may not include a model parameter.

The linear function in the one or more embodiments refers to a function that includes an independent variable x, where the independent variable x can be represented by using only an addition operation and/or a multiplication operation.

During initial construction of the service prediction model, several nonlinear activation functions and several linear activation functions can be used, or only several nonlinear activation functions are used but no linear activation function is used. Through execution of the step, the computing device can convert all the nonlinear activation functions in the service prediction model into the corresponding linear activation functions, and replace the converted linear activation functions with the corresponding nonlinear activation functions in the service prediction model, to obtain a service prediction model that includes only the linear activation functions.

In step S220, the first participant A and the second participant B perform data exchange based on secure multi-party computation according to a logical operation indicated by the linear activation function included in the service prediction model, to jointly perform a prediction process of the service prediction model, where the secure multi-party computation is used to perform data processing based on the linear activation function.

The first participant A and the second participant B can separately perform data exchange based on their respective private data and secure multi-party computation according to the above-mentioned logical operation, to jointly perform a model prediction process.

When the service prediction model is a large language model, the first participant A can be a model party, and the second participant B can be a data party. The data party performs a joint operation between a to-be-queried text in a cryptographic form and a model parameter of the model party through the MPC technology, to obtain a reasoning result for the to-be-queried text by using a large language model of the model party.

Execution of step S210 and execution of step S220 can be spaced apart by a relatively long time, step S210 can be performed in advance, and step S220 can be performed when required.

When the service prediction model is a trained model, when a prediction process is jointly performed on the service prediction model, a model prediction result can be obtained.

When the service prediction model is an untrained model, the first participant A and the second participant B can be used to jointly train the service prediction model. A prediction process of the service prediction model jointly performed by the first participant A and the second participant B can be understood as a forward calculation process in model training. After the prediction process is performed, the first participant A and the second participant B can further determine a prediction loss based on a prediction result obtained through the prediction process, and update the service prediction model based on the prediction loss. The above-mentioned process can be implemented by using an existing technology. A detailed process is not described in this specification.

The following describes in detail a specific implementation of the function conversion process in step S210.

In step S210, the step of converting all nonlinear activation functions in a service prediction model into corresponding linear activation functions can be implemented by using the following steps 1 and 2.

Step 1: For any nonlinear activation function, alternately search for endpoints and Taylor expansion points of the several segments, so that a difference between a linear function in any segment and the nonlinear activation function is less than the preset threshold.

Step 2: Determine the linear activation function of the nonlinear activation function based on the obtained several segments and corresponding linear functions.

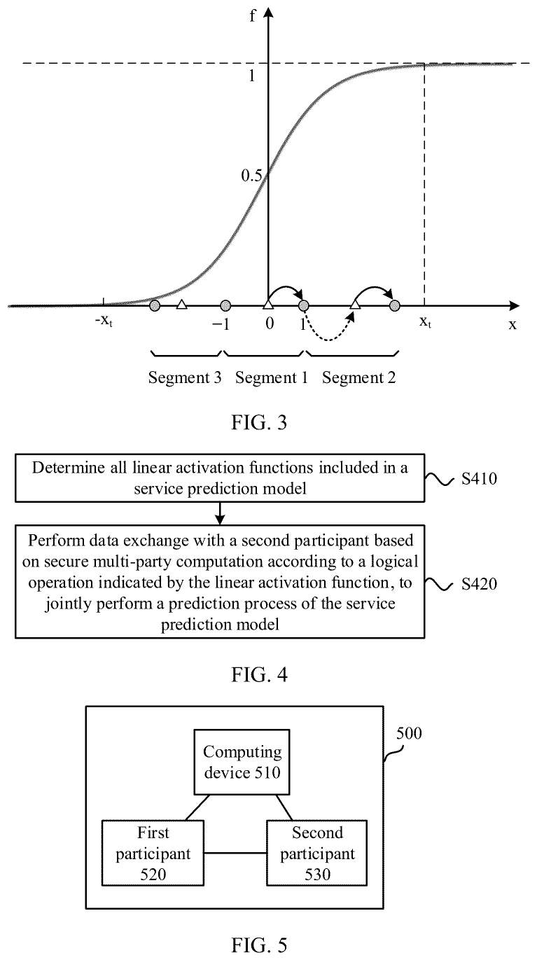

FIG. 3 is a schematic diagram illustrating converting a nonlinear activation function into a segmented linear activation function, according to one or more embodiments. For example, the nonlinear activation function is a Sigmoid function, and a function form of the nonlinear activation function is f(x)=(1+e^{-x})⁻¹. A function value of the function is within [0, 1]. When input data x is greater than x₀, an absolute value of a difference between an output value of the function and 1 is less than the preset threshold. When the input data x is less than −x₀, an absolute value of a difference between an output value of the function and 0 is less than the preset threshold.

If the nonlinear activation function f₁ has a linear part and a nonlinear part, function conversion is performed on the nonlinear part. For example, in the function shown in FIG. 3, two ends of the Sigmoid function approach 0 and 1, and a middle part is a nonlinear part. The middle part [−x₀, x₀] can be referred to as a preset interval of input data.

When step 1 is performed, when the nonlinear activation function f₁ is nonlinear in the preset interval, and the nonlinear activation function approximates a fixed value in another interval different from the preset interval, endpoints and Taylor expansion points of several segments can be alternately searched for in the preset interval. In execution of step 2, the obtained several segments and the corresponding linear functions, the another interval and the corresponding fixed value can be determined as the linear activation function f₁′ of the nonlinear activation function f₁. The preset interval can be predetermined based on a function property of the nonlinear activation function.

For example, for the Sigmoid function, endpoints and Taylor expansion points of several segments can be alternately searched for in an interval [−x₀, x₀] to obtain a plurality of segments and a corresponding linear function, and the plurality of segments, the corresponding linear function, the function being 1 in a case of greater than x₀, and the function being 0 in a case of less than −x₀ are determined as the segmented linear activation functions f₁′.

The following describes in detail an implementation process of alternately searching for endpoints and Taylor expansion points a of several segments.

A segment includes two endpoints, a segment includes one Taylor expansion point, the segment corresponds to the Taylor expansion point, and the Taylor expansion point a is located in the segment. When the Taylor expansion point a is determined, a Taylor series of the nonlinear activation function f₁ at the Taylor expansion point a can be obtained, and the preset quantity of first terms in the Taylor series can be used as a linear function of the segment.

Initially, a preset point is used as a Taylor expansion point. The preset point can be, for example, a=0, that is, an initial Taylor expansion point can be a point 0. The initial Taylor expansion point can alternatively be another selected value, such as a value 1 or a value −1.

When the Taylor expansion point a is known, an endpoint of a segment in which the Taylor expansion point a is located can be searched for, so that a difference between a first linear function and the nonlinear activation function f₁ is less than the preset threshold in a data interval between the Taylor expansion point a and the endpoint.

The first linear function is obtained by performing Taylor expansion on the nonlinear activation function f₁ at the Taylor expansion point a. For example, the first linear function can be in the following form:

$$f ( x ) = f ( a ) + {f}^{′} ( a ) ( x - a ) + ( 1 / 2 ! ) {f}^{″} ( a ) {( x - a )}^{2} \qquad ( 2 )$$

The first linear function takes the first three terms of the Taylor series, that is, includes only terms with a power of 2 or less of an independent variable.

When two endpoints of a segment are determined, a coverage area of the segment is determined. During searching, values of the endpoint x are successively determined by using the Taylor expansion point a as a start value point, and function values respectively of the first linear function and the nonlinear activation function f₁ at each value point are calculated. When a difference between the two function values is not less than the preset threshold, a previous value point of the value point is determined as a value of the endpoint.

For example, as shown in FIG. 3, when the initial Taylor expansion point is 0, values of the endpoint x can be successively determined by using a preset step in a range greater than 0 and less than 0. For example, 0.5 can be the preset step, and values such as 0.5, 1, 1.5, and 2, and values such as −0.5, −1, −1.5, and −2 are selected as values of the endpoint X.

The value of x is substituted into the first linear function and the nonlinear activation function f₁ to respectively obtain a first function value and a second function value, and an absolute value of a difference between the two function values is calculated and used as the difference between the two function values. The difference is compared with the preset threshold. If the difference is less than the preset threshold, it indicates that the value of x is in a coverage range in which the first linear function is located. If the difference is greater than or equal to the preset threshold, it indicates that the value of x is beyond the coverage area of the first linear function. In this case, a previous value of the value of x can be determined as an endpoint of a segment in which the first linear function is located.

Using the Sigmoid function f(x)=(1+e^{-x})⁻¹ as an example, Taylor expansion is performed on the function at a point a=0, and an obtained Taylor series is shown as the equation (2). When the value of x is 1, x=1 is substituted into the equation (2) to obtain a first function value, and is substituted into f(x)=(1+e^{-x})⁻¹ to obtain a second function value. Two endpoints can be obtained by separately performing searching left and right sides of the Taylor expansion point 0, and the two endpoints determine a segment in which the Taylor expansion point 0 is located.

When an endpoint of a segment is known, a Taylor expansion point in the segment is searched for, so that a difference between a second linear function and the nonlinear activation function f₁ is less than the preset threshold in a data interval between the endpoint and the Taylor expansion point.

The second linear function is obtained by performing Taylor expansion on the nonlinear activation function f₁ at the Taylor expansion point. A form of the second linear function is also similar to the equation (2).

Because endpoints of adjacent segments overlap, after one segment is determined, an endpoint of the segment can be used as one of two endpoints of a to-be-determined segment to search for the other endpoint of the to-be-determined segment. For example, as shown in FIG. 3, when it is determined that a segment 1 in which the Taylor expansion point 0 is located is a coverage area of [−1, 1], Taylor expansion points in a segment 2 and a segment 3 can be further determined by using 1 as a left endpoint of the segment 2 on a right side of the segment 1, and using −1 as a right endpoint of the segment 3 on a left side of the segment 1. On an x axis of FIG. 3, an endpoint of a segment is represented by a circle, and a Taylor expansion point of a segment is represented by a triangle.

When the Taylor expansion point is searched for, values of the Taylor expansion point a are successively determined by using an endpoint x of a known segment as a start value point, and corresponding function values respectively of the second linear function and the nonlinear activation function f₁ at the endpoint x are calculated. The obtained endpoint x of the segment is a known endpoint of a neighboring unknown segment. When a difference between the two function values is not less than the preset threshold, a previous value of the Taylor expansion point is determined as a value of the Taylor expansion point in the segment.

When the Taylor expansion point is searched for, for the second linear function shown in the equation (2), the value of x is known and an unknown parameter is a. When a value is selected for a, a value can be selected in a direction greater than or less than the value of x.

For example, in FIG. 3, for the to-be-determined segment 2, the left endpoint of the segment 2 is x=1, a right endpoint is unknown, and a Taylor expansion point in the segment 2 is unknown. When the Taylor expansion point a in the segment 2 is searched for, valued of the Taylor expansion point a can be successively determined by using a preset step of 0.2 in a direction in which x is greater than 1. For example, values such as 1.2, 1.4, and 1.6 can be selected as values of the Taylor expansion point a.

The above-mentioned value of a and the known endpoint x=1 are respectively substituted into the second linear function and the nonlinear activation function f₁ to obtain a first function value and a second function value, and an absolute value of a difference between the two function values is calculated and used as the difference between the two function values. The difference is compared with the preset threshold. If the difference is less than the preset threshold, it indicates that the value of a does not satisfy the Taylor expansion point required in the to-be-determined segment 2. If the difference is greater than or equal to the preset threshold, it indicates that the value of a exceeds the Taylor expansion point required in the segment 2. In this case, a previous value of the value of a can be determined as a value of the Taylor expansion point a in the segment in which the second linear function is located.

As shown by a solid-line arrow and a dotted-line arrow in FIG. 3, in a value range of the independent variable x of the nonlinear activation function f₁, endpoints and Taylor expansion points a of segments can be alternately searched for to obtain a plurality of segments and corresponding Taylor expansion points a, and a corresponding linear function can be obtained by expanding the nonlinear activation function f₁ based on the Taylor expansion point.

When coverage areas of the segments obtained through alternating search cover an entire preset interval, the search can be stopped.

In the one or more embodiments, alternately searching for endpoints and Taylor expansion points of several segments is actually a process of searching for a plurality of segments and linear functions of the segments. In the one or more embodiments, a nonlinear activation function can be converted into a linear activation function in a form of a segmented polynomial, so that a calculation requirement of secure multi-party computation can be satisfied. In addition, in the one or more embodiments, activation function approximation can be performed based on any given precision, and it is only required to set a preset threshold in a search process based on desired approximate precision, to automatically find an approximate function that satisfies the given precision by using a program. The linear activation function generated in this manner can approach the original nonlinear activation function as precisely as possible, thereby ensuring accuracy of secure multi-party computation jointly performed by a plurality of parties.

In addition, the linear activation function generated in the one or more embodiments does not need to be manually designed, does not need to be provided based on experience, and has relatively high scalability. Compared with a solution in which a high-power Taylor series is used to replace a nonlinear activation function, in the one or more embodiments, a low-power linear function of a plurality of segments is used to replace a nonlinear activation function, so that a calculation amount of secure multi-party computation can be greatly reduced, and overall processing efficiency can be improved.

Based on the above-mentioned one or more embodiments shown in FIG. 2, one or more embodiments shown in FIG. 4 can be obtained. The following describes the one or more embodiments in FIG. 4 in detail.

FIG. 4 is another schematic flowchart illustrating a privacy-preserving multi-party joint model prediction method, according to one or more embodiments. The method is performed by using any first participant A, and includes the following steps.

Step S410: Determine all linear activation functions included in a service prediction model.

All the nonlinear activation functions in the service prediction model are converted into corresponding linear activation functions, where a linear activation function converted from any nonlinear activation function includes linear functions of several segments, the linear function is obtained by performing Taylor expansion on the nonlinear activation function at a Taylor expansion point in a corresponding segment, and in the segment, a difference between the linear function and the nonlinear activation function is less than a preset threshold.

Step S420: Perform data exchange with a second participant B based on secure multi-party computation according to a logical operation indicated by the linear activation function, to jointly perform a prediction process of the service prediction model, where the secure multi-party computation is used to perform data processing based on the linear activation function.

In the one or more embodiments, the first participant A serves as an execution entity, and performs the above-mentioned steps through a data exchange process with the second participant B. In step S410, the step of determining all linear activation functions included in a service prediction model can include obtaining all the linear activation functions included in the service prediction model, for example, obtaining from a computing device. The computing device performs the step of converting the nonlinear activation functions in the service prediction model into corresponding linear activation functions. When the first participant A is the computing device, the first participant A can obtain a service prediction model obtained after the nonlinear activation functions are converted into the corresponding linear activation functions in advance.

The one or more embodiments shown in FIG. 4 are obtained based on the one or more embodiments shown in FIG. 2. For related descriptions, references can be made to each other. Detailed descriptions are not described herein again.

In this specification, “first” in words such as the first participant and the first linear function, and corresponding “second” (if present) in this specification are merely used for ease of distinguishing and description, and have no limitation meaning.

In this specification, the computing device, the first participant, and the second participant can be implemented by any apparatus, device, platform, device cluster, etc. having computing and processing capabilities.

The above-mentioned content describes specific embodiments of this specification, and other embodiments fall within the scope of the appended claims. In some cases, the actions or steps described in the claims can be performed in an order different from that in the embodiments and the desired results can still be achieved. In addition, the process depicted in the accompanying drawings does not necessarily need a particular order shown or a sequential order to achieve the desired results. In some implementations, multitasking and concurrent processing is feasible or may be advantageous.

FIG. 5 is a schematic block diagram illustrating a privacy-preserving multi-party joint model prediction system, according to one or more embodiments. The system includes a computing device 510, a first participant 520, and a second participant 530.

The computing device 510 is configured to convert all nonlinear activation functions in a service prediction model into corresponding linear activation functions, where a linear activation function converted from any nonlinear activation function includes linear functions of several segments, the linear function is obtained by performing Taylor expansion on the nonlinear activation function at a Taylor expansion point in a corresponding segment, and in the segment, a difference between the linear function and the nonlinear activation function is less than a preset threshold.

The first participant 520 and the second participant 530 are configured to perform data exchange based on secure multi-party computation according to a logical operation indicated by the linear activation function included in the service prediction model, to jointly perform a prediction process of the service prediction model, where the secure multi-party computation is used to perform data processing based on the linear activation function.

In a shown implementation, the computing device 510 is specifically configured to:
for any nonlinear activation function, alternately search for endpoints and Taylor expansion points of the several segments, so that a difference between a linear function in any segment and the nonlinear activation function is less than the preset threshold; and
determine the linear activation function of the nonlinear activation function based on the obtained several segments and corresponding linear functions.

In an implementation, when alternately searching for the endpoints and the Taylor expansion points of the several segments, the computing device 510 is configured to:
initially, use a preset point as a Taylor expansion point.

In an implementation, when alternately searching for the endpoints and the Taylor expansion points of the several segments, the computing device 510 is configured to:
in a preset interval, alternately search for the endpoints and the Taylor expansion points of the several segments, where in another interval different from the preset interval, the nonlinear activation function approximates a fixed value.

When determining the linear activation function of the nonlinear activation function, the computing device 510 is configured to:
determine the obtained several segments and the corresponding linear functions, and the another interval and the corresponding fixed value as the linear activation function of the nonlinear activation functions.

In an implementation, when alternately searching for the endpoints and the Taylor expansion points of the several segments, the computing device 510 is configured to:
when a Taylor expansion point is known, search for an endpoint of a segment in which the Taylor expansion point is located, so that a difference between the first linear function and the nonlinear activation function is less than the preset threshold in a data interval between the Taylor expansion point and the endpoint, where the first linear function is obtained by performing Taylor expansion on the nonlinear activation function at the Taylor expansion point; and
when an endpoint of a segment is known, search for a Taylor expansion point in the segment, so that a difference between a second linear function and the nonlinear activation function is less than the preset threshold in a data interval between the endpoint and the Taylor expansion point, where the second linear function is obtained by performing Taylor expansion on the nonlinear activation function at the Taylor expansion point.

In an implementation, when searching for the endpoint of the segment in which the Taylor expansion point is located, the computing device 510 is configured to:
successively determine values of the endpoint by using the Taylor expansion point as a start value point;
calculate function values of the first linear function and the nonlinear activation function at each value point; and
when a difference between the two function values is not less than the preset threshold, determine a previous value point of the value point as a value of the endpoint.

In an implementation, when searching for the Taylor expansion point in the segment, the computing device 510 is configured to:
successively determine values of the Taylor expansion point by using the endpoint as a start value point;
calculate corresponding function values respectively of the second linear function and the nonlinear activation function at the endpoint; and
when a difference between the two function values is not less than the preset threshold, determine a previous value of the Taylor expansion point as a value of the Taylor expansion point in the segment.

In an implementation, the linear function takes a preset quantity of terms in a corresponding Taylor series.

The system embodiments correspond to the method embodiments shown in FIG. 2. For specific descriptions, references can be made to the descriptions in the method embodiments. Details are omitted here for simplicity. The system embodiments are obtained based on the corresponding method embodiments, and have the same technical effects as the corresponding method embodiments. For specific descriptions, references can be made to the corresponding method embodiments.

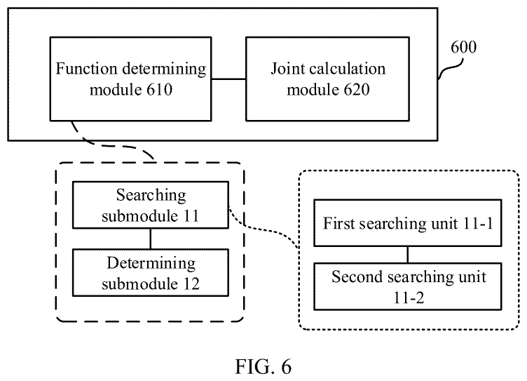

FIG. 6 is a schematic block diagram illustrating a privacy-preserving multi-party joint model prediction apparatus, according to one or more embodiments. The apparatus embodiments correspond to the method embodiments shown in FIG. 4. The apparatus 600 is deployed in a first participant, and the apparatus 600 includes:
a function determining module 610, configured to determine all linear activation functions in a service prediction model, where all the nonlinear activation functions in the service prediction model are converted into corresponding linear activation functions, a linear activation function converted from any nonlinear activation function includes linear functions of several segments, the linear function is obtained by performing Taylor expansion on the nonlinear activation function at a Taylor expansion point in a corresponding segment, and in the segment, a difference between the linear function and the nonlinear activation function is less than a preset threshold; and
a joint calculation module 620, configured to perform data exchange with a second participant based on secure multi-party computation according to a logical operation indicated by the linear activation function, to jointly perform a prediction process of the service prediction model, where the secure multi-party computation is used to perform data processing based on the linear activation function.

In an implementation, the function determining module 610 includes a searching submodule 11 and a determining submodule 12.

The searching submodule 11 is configured to: for any nonlinear activation function, alternately search for endpoints and Taylor expansion points of the several segments, so that a difference between a linear function in any segment and the nonlinear activation function is less than the preset threshold.

The determining submodule 12 is configured to determine the linear activation function of the nonlinear activation function based on the obtained several segments and corresponding linear functions.

In an implementation, the searching submodule 11 is specifically configured to:
initially, use a preset point as a Taylor expansion point.

In an implementation, the searching submodule 11 is specifically configured to:
in a preset interval, alternately search for the endpoints and the Taylor expansion points of the several segments, where in another interval different from the preset interval, the nonlinear activation function approximates a fixed value.

The determining submodule 12 is specifically configured to:
determine the obtained several segments and the corresponding linear functions, and the another interval and the corresponding fixed value as the linear activation function of the nonlinear activation functions.

In an implementation, the searching submodule 11 includes:
a first searching unit 11-1, configured to: when a Taylor expansion point is known, search for an endpoint of a segment in which the Taylor expansion point is located, so that a difference between the first linear function and the nonlinear activation function is less than the preset threshold in a data interval between the Taylor expansion point and the endpoint, where the first linear function is obtained by performing Taylor expansion on the nonlinear activation function at the Taylor expansion point; and
a second searching unit 11-2, configured to: when an endpoint of a segment is known, search for a Taylor expansion point in the segment, so that a difference between a second linear function and the nonlinear activation function is less than the preset threshold in a data interval between the endpoint and the Taylor expansion point, where the second linear function is obtained by performing Taylor expansion on the nonlinear activation function at the Taylor expansion point.

In an implementation, the first searching unit 11-1 is specifically configured to:
successively determine values of the endpoint by using the Taylor expansion point as a start value point;
calculate function values of the first linear function and the nonlinear activation function at each value point; and
when a difference between the two function values is not less than the preset threshold, determine a previous value point of the value point as a value of the endpoint.

In an implementation, the second searching unit 11-2 is specifically configured to:
successively determine values of the Taylor expansion point by using the endpoint as a start value point;
calculate corresponding function values respectively of the second linear function and the nonlinear activation function at the endpoint; and
when a difference between the two function values is not less than the preset threshold, determine a previous value of the Taylor expansion point as a value of the Taylor expansion point in the segment.

In an implementation, the first participant is a model owner, and the second participant is a data owner.

The apparatus embodiments correspond to the method embodiments. For specific descriptions, references can be made to the descriptions in the method embodiments. Details are omitted here for simplicity. The apparatus embodiments are obtained based on the corresponding method embodiments, and have the same technical effects as the corresponding method embodiments. For specific descriptions, references can be made to the corresponding method embodiments.

One or more embodiments of this specification further provide a computer-readable storage medium. The computer-readable storage medium stores a computer program. When the computer program is executed in a computer, the computer is enabled to perform the method described in any one of FIG. 1 to FIG. 4.

One or more embodiments of this specification further provides a computing device, including a memory and a processor. The memory stores executable code, and when the processor executes the executable code, the method in any one of FIG. 1 to FIG. 4 is implemented.

The embodiments of this specification are described in a progressive way. For same or similar parts in the embodiments, references can be made to each other. Each embodiment focuses on a difference from another embodiment. In particular, the embodiments of the storage medium and the computing device are basically similar to the method embodiments, and therefore are described briefly. For related parts, references can be made to related descriptions in the method embodiments.

A person skilled in the art should be aware that in the one or more examples, functions described in the embodiments of this specification can be implemented by hardware, software, firmware, or any combination thereof. When the functions are implemented by using software, the functions can be stored in a computer-readable medium or transmitted as one or more instructions or code in the computer-readable medium.

The above-mentioned specific implementations further describe the objectives, technical solutions, and beneficial effects of the embodiments of this specification in detail. It should be understood that the above-mentioned descriptions are merely specific implementations of the embodiments of this specification, but are not intended to limit the protection scope of this specification. Any modification, equivalent replacement, improvement, etc. made based on the technical solutions of this specification shall fall within the protection scope of this specification.

1. A privacy-preserving multi-party joint model prediction method, wherein the method comprises:
converting, by a computing device, all nonlinear activation functions in a service prediction model into corresponding linear activation functions, wherein a linear activation function converted from any nonlinear activation function comprises linear functions of several segments, the linear function is obtained by performing Taylor expansion on the nonlinear activation function at a Taylor expansion point in a corresponding segment, and in the segment, a difference between the linear function and the nonlinear activation function is less than a preset threshold; and
performing, by a first participant and a second participant, data exchange based on secure multi-party computation according to a logical operation indicated by the linear activation function comprised in the service prediction model, to jointly perform a prediction process of the service prediction model, wherein the secure multi-party computation is used to perform data processing based on the linear activation function.

2. The method according to claim 1, wherein the step of converting all nonlinear activation functions in a service prediction model into corresponding linear activation functions comprises:
for any nonlinear activation function, alternately searching for endpoints and Taylor expansion points of several segments, so that a difference between a linear function in any segment and the nonlinear activation function is less than the preset threshold; and
determining the linear activation function of the nonlinear activation function based on the obtained several segments and corresponding linear functions.

3. The method according to claim 2, wherein the step of alternately searching for endpoints and Taylor expansion points of several segments comprises:
initially, using a preset point as a Taylor expansion point.

4. The method according to claim 2, wherein the step of alternately searching for endpoints and Taylor expansion points of several segments comprises:
in a preset interval, alternately searching for the endpoints and the Taylor expansion points of the several segments, wherein in another interval different from the preset interval, the nonlinear activation function approximates a fixed value; and
the step of determining the linear activation function of the nonlinear activation function comprises:
determining the obtained several segments and the corresponding linear functions, and the another interval and the corresponding fixed value as the linear activation function of the nonlinear activation functions.

5. The method according to claim 2, wherein the step of alternately searching for endpoints and Taylor expansion points of several segments comprises:
when a Taylor expansion point is known, searching for an endpoint of a segment in which the Taylor expansion point is located, so that a difference between a first linear function and the nonlinear activation function is less than the preset threshold in a data interval between the Taylor expansion point and the endpoint, wherein the first linear function is obtained by performing Taylor expansion on the nonlinear activation function at the Taylor expansion point; and
when an endpoint of a segment is known, searching for a Taylor expansion point in the segment, so that a difference between a second linear function and the nonlinear activation function is less than the preset threshold in a data interval between the endpoint and the Taylor expansion point, wherein the second linear function is obtained by performing Taylor expansion on the nonlinear activation function at the Taylor expansion point.

6. The method according to claim 5, wherein the step of searching for an endpoint of a segment in which the Taylor expansion point is located comprises:
successively determining values of the endpoint by using the Taylor expansion point as a start value point;
calculating function values of the first linear function and the nonlinear activation function at each value point; and
when a difference between the two function values is not less than the preset threshold, determining a previous value point of the value point as a value of the endpoint.

7. The method according to claim 5, wherein the step of searching for a Taylor expansion point in the segment comprises:
successively determining values of the Taylor expansion point by using the endpoint as a start value point;
calculating corresponding function values respectively of the second linear function and the nonlinear activation function at the endpoint; and
when a difference between the two function values is not less than the preset threshold, determining a previous value of the Taylor expansion point as a value of the Taylor expansion point in the segment.

8. The method according to claim 1, wherein the linear function takes a preset quantity of terms in a corresponding Taylor series.

9. A privacy-preserving multi-party joint model prediction method, performed by a first participant, wherein the method comprises:
determining all linear activation functions in a service prediction model, wherein all the nonlinear activation functions in the service prediction model are converted into corresponding linear activation functions, a linear activation function converted from any nonlinear activation function comprises linear functions of several segments, the linear function is obtained by performing Taylor expansion on the nonlinear activation function at a Taylor expansion point in a corresponding segment, and in the segment, a difference between the linear function and the nonlinear activation function is less than a preset threshold; and
performing data exchange with a second participant based on secure multi-party computation according to a logical operation indicated by the linear activation function, to jointly perform a prediction process of the service prediction model, wherein the secure multi-party computation is used to perform data processing based on the linear activation function.

10. A privacy-preserving multi-party joint model prediction system, wherein the system comprises:
a computing device, configured to convert all nonlinear activation functions in a service prediction model into corresponding linear activation functions, wherein a linear activation function converted from any nonlinear activation function comprises linear functions of several segments, the linear function is obtained by performing Taylor expansion on the nonlinear activation function at a Taylor expansion point in a corresponding segment, and in the segment, a difference between the linear function and the nonlinear activation function is less than a preset threshold; and
a first participant and a second participant, configured to perform data exchange based on secure multi-party computation according to a logical operation indicated by the linear activation function comprised in the service prediction model, to jointly perform a prediction process of the service prediction model, wherein the secure multi-party computation is used to perform data processing based on the linear activation function.

11. A privacy-preserving multi-party joint model prediction apparatus, deployed in a first participant, wherein the apparatus comprises:
a function determining module, configured to determine all linear activation functions in a service prediction model, wherein all the nonlinear activation functions in the service prediction model are converted into corresponding linear activation functions, a linear activation function converted from any nonlinear activation function comprises linear functions of several segments, the linear function is obtained by performing Taylor expansion on the nonlinear activation function at a Taylor expansion point in a corresponding segment, and in the segment, a difference between the linear function and the nonlinear activation function is less than a preset threshold; and
a joint calculation module, configured to perform data exchange with a second participant based on secure multi-party computation according to a logical operation indicated by the linear activation function, to jointly perform a prediction process of the service prediction model, wherein the secure multi-party computation is used to perform data processing based on the linear activation function.

12. A computer-readable storage medium, wherein the computer-readable storage medium stores a computer program, and when the computer program is executed in a computer, the computer is enabled to perform the method according to any one claims 1 to 9.

13. A computing device, comprising a memory and a processor, wherein the memory stores executable code, and when the processor executes the executable code, the method according to any one of claims 1 to 9 is implemented.
